(19) United States
(12) Patent Application Publication
(10) Pub. No.: US 2013/0074150 A1
(43) Pub. Date: Mar. 21, 2013

(54) Presenting Visual Challenges for Verifying Human Interaction

(71) Applicant: Kenneth Soohoo, Redwood Shores, CA (US)

(72) Inventor: Kenneth Soohoo, Redwood Shores, CA (US)

(73) Assignee: Monotype Imaging Inc.

(21) Appl. No.: 13/237,273

(22) Filed: Sep. 20, 2011

(51) Int. Cl. G06F 21/22

(52) U.S. Cl. 726/3

(57) ABSTRACT

A computing device-implemented method includes providing a presentable visual challenge for determining if access should be granted. The visual challenge includes presenting obscured text wherein the manner in which the text is obscured changes over a period of time. The method also includes determining if a received response substantially matches the text to determine if access should be granted.

### BACKGROUND

This description relates to presenting challenges to verify human interactions such as to assure that a human is interacting with a computing device.

In the ever-expanding arena of providing services over computing device networks (such as the Internet), the need for providing security measures has similarly increased to confront malicious activities such as automated programs abusively accessing online services. For some security techniques, the actual human users interacting with the services are asked to perform tasks that a rogue computer would be unable to complete. However, with the continued development of computing technology, security measure development needs to diligently keep pace.

### SUMMARY

The systems and techniques described here relate to introducing a temporal aspect to visual challenges presented for verifying interactions with human users.

In one aspect, a computing device-implemented method includes providing a presentable visual challenge for determining if access should be granted. The visual challenge includes presenting obscured text wherein the manner in which the text is obscured changes over a period of time. The method also includes determining if a received response substantially matches the text to determine if access should be granted.

Implementations may include any or all of the following features. The manner in which the text is obscured may include blocking a portion of the text from being viewed. The blocked portion of the text may extend along a horizontal direction, a vertical direction, etc. The manner in which the text is obscured may include blocking non-overlapping portions of the text from being viewed over the period of time. The manner in which the text is obscured may include randomly presenting different portions of the text over the period of time. The manner in which the text is obscured may include distorting a portion of the text. The manner in which the text is obscured may include presenting a subset of one or more characters included in the text during one portion of the time period and a different subset of one or more characters included in the text during another portion of the time period. Providing a presentable visual challenge may include a server device sending data that represents the presentable visual challenge to a client device for display. If a match is determined, a client device may be granted access to a server device.

In another aspect, a system includes a computing device for providing a presentable visual challenge for determining if access should be granted to a resource. The visual challenge includes presenting obscured text wherein the manner in which the text is obscured changes over a period of time. The computing device is configured to determine if a received response substantially matches the text to determine if access should be granted.

Implementations may include any or all of the following features. The manner in which the text is obscured may include blocking a portion of the text from being viewed. The blocked portion of the text may extend along a horizontal direction, a vertical direction, etc. The manner in which the text is obscured may include blocking non-overlapping portions of the text from being viewed over the period of time. The manner in which the text is obscured may include randomly presenting different portions of the text over the period of time. The manner in which the text is obscured may include distorting a portion of the text. The manner in which the text is obscured may include presenting a subset of one or more characters included in the text during one portion of the time period and a different subset of one or more characters included in the text during another portion of the time period. Providing a presentable visual challenge may include the computing device sending data that represents the presentable visual challenge to a client device for display. If a match is determined, a client device may be granted access to the resource.

In still another aspect, a computing device includes a memory configured to store instructions and a processor configured to execute the instructions to perform a method. The method includes providing a presentable visual challenge for determining if access should be granted. The visual challenge includes presenting obscured text wherein the manner in which the text is obscured changes over a period of time. The method also includes determining if a received response substantially matches the text to determine if access should be granted.

Implementations may include any or all of the following features. The manner in which the text is obscured may include blocking a portion of the text from being viewed. The blocked portion of the text may extend along a horizontal direction, a vertical direction, etc. The manner in which the text is obscured may include blocking non-overlapping portions of the text from being viewed over the period of time. The manner in which the text is obscured may include randomly presenting different portions of the text over the period of time. The manner in which the text is obscured may include distorting a portion of the text. The manner in which the text is obscured may include presenting a subset of one or more characters included in the text during one portion of the time period and a different subset of one or more characters included in the text during another portion of the time period. Providing a presentable visual challenge may include a server device sending data that represents the presentable visual challenge to a client device for display. If a match is determined, a client device may be granted access to a server device.

These and other aspects and features and various combinations of them may be expressed as methods, apparatus, systems, means for performing functions, program products, and in other ways.

Other features and advantages will be apparent from the description and the claims.

### DESCRIPTION OF DRAWINGS

FIG. 1 illustrates a user interface presenting a visual challenge for user verification.

FIG. 2 illustrates is a block diagram of an Internet based computer network.

FIGS. 3 and 4 illustrate visual challenges that change over a period of time.

FIG. 5 is a representative flow chart of operations for verifying human interaction that implement a visual challenge that changes over time.

FIG. 6 is a block diagram of computing devices and systems.

### DETAILED DESCRIPTION

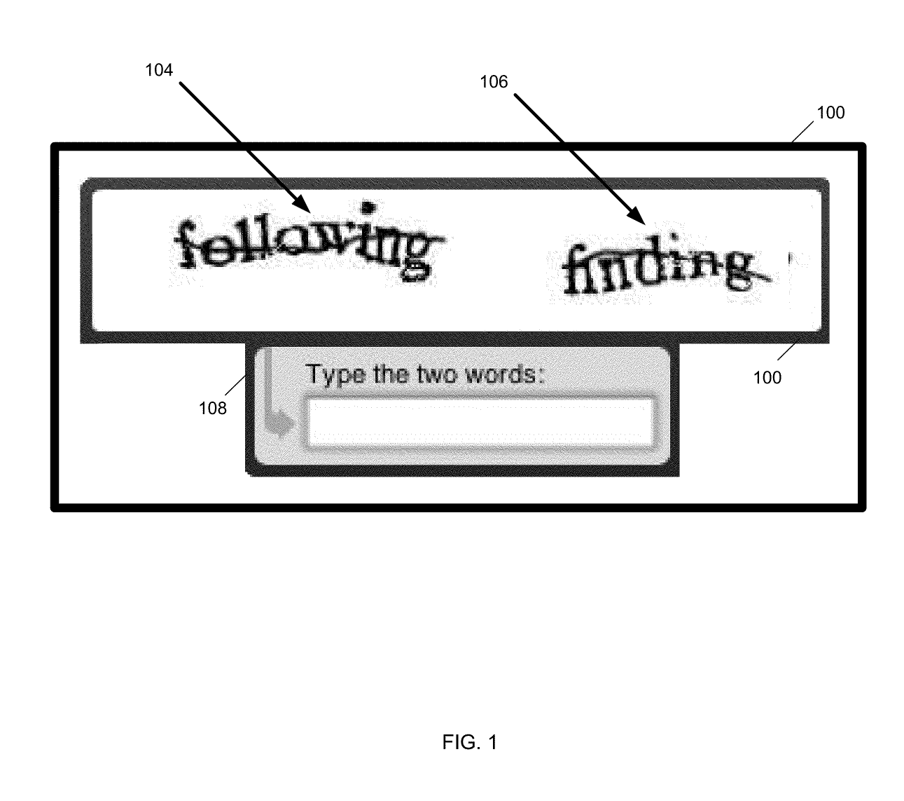

Referring to FIG. 1, a user interface 100 is illustrated that presents a visual challenge for verifying human interaction with the interface. By employing such user interfaces, rogue users that have deployed automated scripts or software agents (known as “bots” in some instances) may be detected and potentially blocked from executing their malicious activities such as registering a multitude of people for a network service (e.g., a free email accounts), skewing the results of polls with online voting, etc. Various techniques may be implemented to provide such user interfaces, for example, a CAPTCHA (which stands for “Completely Automated Public Turing test to tell Computers and Humans Apart”) may be implemented as illustrated by the user interface 100. In general, a CAPTCHA can be considered a challenge-response test that attempts to ensure that the response is produced by an individual rather than by executed instructions or other type of automated process. Typically, the challenge-response test is provided over a finite period of time that can be considered a session (e.g., a response may need to be input within a finite period of time). To provide such functionality, in general, distorted or visually obscured text characters are presented in a user interface and the user is asked to identify the undistorted or non-obscured text. For example, as illustrated in the figure, a portion 102 of the user interface 100 presents two words 104, 106 that have been obscured by wavy lines. While obscured, each of the characters included in the two words 104, 106 is generally recognizable by a human user. Along with presenting the words for identification, in this example, the user interface 100 also provides a field 108 for the user to input what he or she understands to be the presented two words. Once entered, the input from the user compared to the two words presented in the distorted form by the portion 102 of the user interface 100. Along with locally executing the comparison (e.g., on the computing device used to present the user interface), remote execution (e.g., a remotely located server associated with an Internet site) or a combination of locally and remotely executed operations may be used for comparing the data sets.

Along with the illustrated technique of striking a wavy line through the two words 104, 106, a CAPTCHA may use other techniques to distort text to increase the level of difficulty for an automated process to identify the words. For example, the textual characters may be blurred or partially obscured in an attempt to reduce the probability of being identified (e.g., by a “bot”). Further, the level of distortion may be increased for some characters and not for others. As such, some characters may be extremely difficult to identify but in the context of other characters, a human user may be likely to recognize the term as a whole and fill in the extremely distorted character or characters. The position a character is placed may also assist in distorting words, for example, by tightly crowding characters together, a human may be able to recognize the characters and words upon close review while an automated process would be unable. However, as development efforts continue to produce more sophisticated automated processes, the probability may increase that such processes may become capable of identifying and recognizing characters and words presented in the distorted forms or obscured views. Correspondingly, CAPTCHAs may be developed that further distort the presented characters (e.g., use new distortion techniques) until these static images reach the very edge of being identifiable by a human user. While applying such additional or more advanced distortion techniques may reduce the probability of an automated process identifying the presented text, such increased distortion may also begin to frustrate the human user attempting to visually decode the presented text and may result in less user traffic and interest in the information being secured by the CAPTCHA.

Rather than increasing the amount of distortion used to present one or more security words, other techniques may be used to present text that may be recognizable by a human user but very difficult for an automated process to recognize. For example, the presented view of the text may change over time. As such, a human user observing the visually changing text may be able to identify the underlying text while an automated process would be unable to identify the visually changing appearance of the presented text. Along with potentially reducing the amount of focus needed to for a human user to identify the text (while not lowering the level of provided security), using visually changing text in a challenge-response test may assist some human users. For example, visually impaired, older aged individuals (e.g., senior citizens, elderly, etc.), children, less experienced users of computing devices, etc. may find identifying the text presented in a visually changing form less strenuous for various types of computing platforms (e.g., computer systems, tablet computing devices, smart devices, etc.).

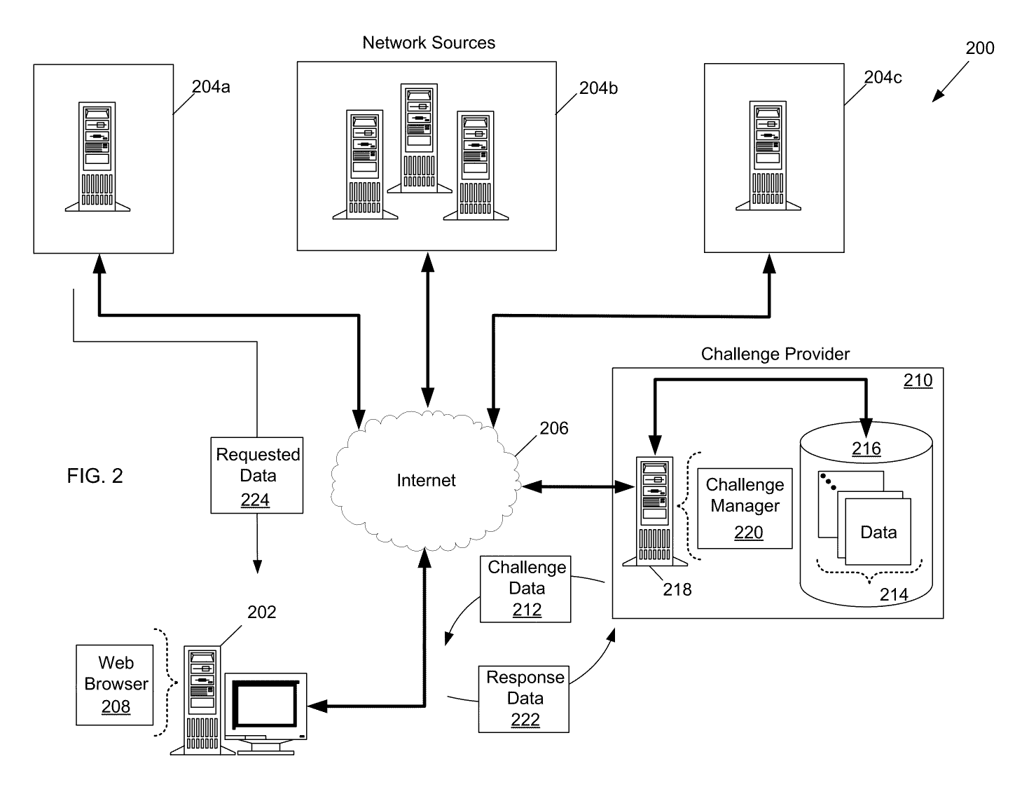

Referring to FIG. 2, one or more types of systems may be implemented for providing challenge-response tests that incorporate visually changing text (while being observed by an end user). For example, challenge-response test production and presentation may be provided by operations executed by a single computing device (e.g., computer system, tablet computing device, smart phone, etc.). Such operations may also be executed by multiple devices to provide a challenge-response test to an end-user device (e.g., laptop computer, cellular telephone, etc.) for accessing a remote source. In some arrangements, the challenge-response test production and distribution (e.g., for managing access) may be provided as a network service for multiple network information sources. As illustrated in the figure, a computer network 200 is presented that includes a computer system 202 that a human user may interact (e.g., using a keyboard or pointing device such as a mouse) for accessing various network sources of interest (e.g., represented as network sources 204 a,b,c) through one or more networks (e.g., the Internet 206). As illustrated, in this particular example a web browser 208 is executed by the computer system 202 for accessing the network sources 204 a,b,c (e.g., one or more other computing devices, servers, etc.). Once the resource (e.g., network source 204a) has been identified (e.g., from a webpage presented on the computer system 202), a request may be sent via the web browser 208 for accessing data residing at the network source.

Prior to being provided the requested data from the network source 204a, a challenge-response test needs to be passed, in this example, to verify that the user of the computer system 202 is in fact a human being and not an automated process (e.g., a “bot”). In this arrangement the challenge-response test is provided as a network service by a challenge provider 210. Once notified by the network source (which access is requested) or by another entity, the challenge provider 210 produces a challenge-response test and sends data (e.g., challenge data 212) to the appropriate computing device that has requested access to the source (e.g., the computer system 202). To provide the challenge-response test, the challenge provider 210 typically needs to access to one or more libraries of information (or other types of information stores) that may be stored local to or remote from the challenge provider. As represented in the figure, a library of challenge data 214 (e.g., text, words, etc.) is shown being stored in a storage device 216 (e.g., one or more hard drives, CD-ROMs, etc.) on site. In this arrangement, a server 218 executes a challenge manager 220 that provides operations for producing the challenge data 212. For example, along with accessing the library of challenge data 214 residing in the storage device 216, the challenge manager 220 may also produce data (e.g., executable instructions, functions, etc.) such that the challenge-response test presented to the user changes over a period of time. The challenge manager 220 may also define the session during which the challenge-response test is held (e.g., a finite amount of time for a response to be input). Further, along with producing and providing the challenge-response test to the computing device (e.g., computer system 202), the challenge manager 220 may also be capable of receiving response data 222 (e.g., from the computer system 202) and determining if the response data appropriately matches the text (e.g., retrieved from the library of challenge data 214) used to produce the challenge-response test. One or more techniques may be implemented to define a match, for example, if a predefined threshold number of characters has been correctly input, a match may be declared. If determined that the response data 222 matches (or substantially matches) the text from the challenge data library 214, access is typically granted and the appropriate network source (e.g., network source 204a) is notified that access be granted and requested data 224 may be prepared and sent to the requesting device (e.g., computer system 202). If an appropriate match is not detected, the challenge provider 210 may alert the network source to not grant access and the requesting device may be informed (e.g., by the challenge provider 210, the network source 204a, etc.) that an appropriate response has not been provided. Further, in some arrangements, upon not passing a challenge-response test, a new challenge-response test may be presented to the requesting device (e.g., after being constructed by the challenge provider 210 to include new test data from the challenge data library 214) with or without being requested by the requesting device or the user of the requesting device. Similar to the initially provided challenge-response test, the subsequently provided challenge-response test may include text that is presented in a view that varies over time (while being viewed by the requesting device user).

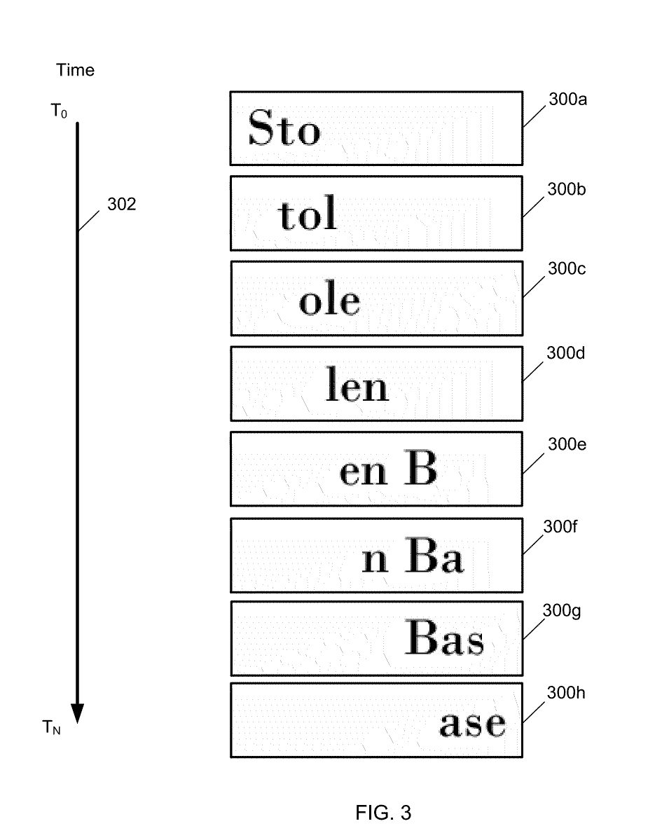

Referring to FIG. 3, one or more techniques and methodologies may be implemented for presenting text in a challenge-response test (e.g., a CAPTCHA) such that the view of the text changes over the presentation time period. For example, the portion of the text presented for viewing (and correspondingly, the portion of the text obscured) may be varied over time. As illustrated in the figure, portions of a challenge phrase “Stolen Base” may be presented (e.g., on the display of the user device, such as computer system 202, shown in FIG. 2) over a period of time. Due to the temporal aspect, the presented challenge phrase appears as a short video or movie clip to the casual observer. In some arrangements, the phrase may be presented by one or more animation engines (e.g., that executes vector operations to provide animated text such as Flash developed by Adobe Systems Incorporated of San Jose, Calif., etc.) Further, an automated process would be unable or have difficulty decoding the challenge phrase (e.g., identifying each individually presented portion and appropriately combine the presented portions). By providing such difficulties for an automated process based upon the temporal aspect of the challenge, the text of the challenge phrase can be presented without significant distortion (e.g., striking a line through the text, skewing the individual characters, crowding the characters to the point of overlap). As such, the human observer may actually find the challenge phrase easier to decode without the different types of visual distortion being present.

In this illustrated example, a series of eight frames 300a-h are used to present eight corresponding portions of the challenge phrase “Stolen Base” over a period of time as illustrated with timeline 302. In particular, the frames are sequentially presented from the frame 300a, at time T₀, to the frame 300h, at time T_{N}, prior to returning to frame 300a for continuing the present the sequence of eight frames in a repetitive manner. Along with using more or fewer frames for presenting portions of challenge phrase, one or more other types of variations may be implemented for the time varying presentation. For example, individual characters of the challenge phrase may appear in multiple frames to assist the observer with visually combining the portions. As illustrated in the figure, the character “t” appears in frames 300a and 300b and the character “B” appears in frames 100e, 100f and 100g. While overlap may assist an observer with decoding the challenge phrase, in some arrangements, character may only appear in one frame and the content of one frame may not overlap the contents of another frame (e.g., an adjacent frame). Presentation frequency of the individual frames and the repetition frequency of the frame sequence may also be varied. Along changing such frequencies from one challenge-response test to another, the frequencies may be changed during the presentation of a single challenge-response test. For example, the frequency at which the frames 300a-h is presented may be increased or decreased for each repetition through the frame sequence (or after a predetermined number of cycles through the frame sequence). Such frequency variations may also be changed from one challenge-response test being presented to the next. For example, upon failing a challenge-response test (e.g., input from a user does not match a presented challenge phrase), the frequency of presenting the frames (e.g., that contain portions of a new challenge phrase) may be increased or decreased to assist a human observer (if the observer is human) in decoding the challenge phrase from the temporally changing presentation.

Along with presentation frequency and sequence repetition frequency, other presentation parameters may be adjusted over the presentation time. For example, the lighting or brightness may vary from frame to frame (e.g., frame 300a is brighter than frame 300b) or among groups of frames (e.g., frames 300a-d may be set for one brightness level and frames 300e-h may be set for another brightness level). Presentation of the frame sequence itself may also be changed in some arrangements. For example, while the sequence of frames 300a-h is illustrated as being presented such that the challenge phrase “Stolen Base” starts from the left-most characters (e.g., “Sto”) and steps to the right-most characters (e.g., “ase”), the frames may be presented in other orders (e.g., initially present frame 300h and step through to frame 300a). The order that frames are presented may also be randomly determined. For example, each of the frames 300a-h may be randomly presented based on upon the use of a random number generator or other similar technique or methodology.

Along with changing the way in which frames (e.g., frames 300a-h) are presented over time, the content of the frames may be adjusted for presentation appearance. For example, the content of one or more frames may be distorted (e.g., text presented with a strikethrough, skewed characters, crowded characters, etc.). As such, one or more of the frames 300a-300h may include distorted content while the remaining frames (if any) would include undistorted characters.

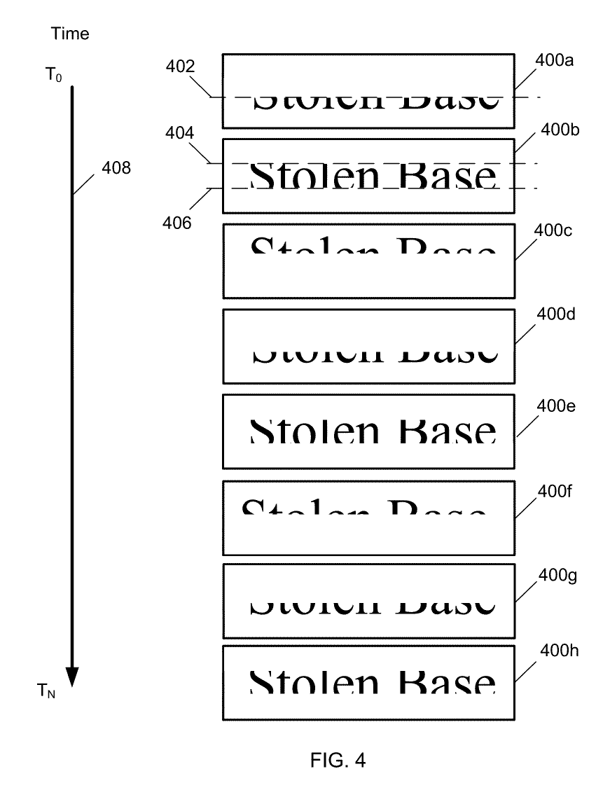

Referring to FIG. 4, other techniques and methodologies may be implemented for presenting portions of a challenge phrase over a period of time (e.g., repetitively presenting a sequence of frames in which each frame displays a portion of the challenge phrase). For example, similar to each frame presenting a subset of the challenge phrase characters, views of other portions of the challenge phrase may be presented by the frames. In one arrangement, as illustrated in the figure, a portion of the entire challenge phrase may be obscured in each frame. In particular, one or more horizontal lines define regions in which a portion of the challenge phrase is viewable and regions in which other portions of the challenge phrase is not viewable. Each frame included in a sequence of frames 400a-h includes at least one region in which a portion of the challenge phrase is viewable and at least one other region in in which the corresponding portion of the challenge phrase is blocked from view. For example, referring to frame 400a, a dashed line 402 defines a lower portion of the frame in which the corresponding portion of the challenge frame is viewable (by an observer) and also defines an upper portion of the frame in which the complementary portion of the challenge frame is blocked from being viewed. Similarly, two dashed lines 404, 406 define three regions of the frame 400b (e.g., an upper and lower region within which the challenge phrase is blocked, and a middle region within which the corresponding portion of the challenge phrase is viewable). Following through the remaining frames, similar regions are defined. For example, frames 400a, 400d and 400g each define similar regions, frames 400b, 400e and 400h define similar regions, and frames 400c and 400f define similar regions.

While horizontally elongated areas of the frames are used to define regions within which the challenge phrase may be viewable, or not, one or more other geometries may also be implemented. For example, vertically or diagonally elongated areas or areas defined by one or more other types of geometries (e.g., circles, triangles, etc.) may be used to define frames regions which may or may not allow viewing of a corresponding portion of a challenge phrase. Similar to the frame sequence presented in FIG. 3, the frames 400a-h are sequentially presented from the frame 400a, at time T₀, to the frame 400h, at time T_{N}, prior to returning to frame 400a and continuing the present the sequence of eight frames in a repetitive manner. The sequence of frames may also be presented by implementing other techniques and methodologies (e.g., changing brightness levels of some frames, changing the order that frames are presented, etc.).

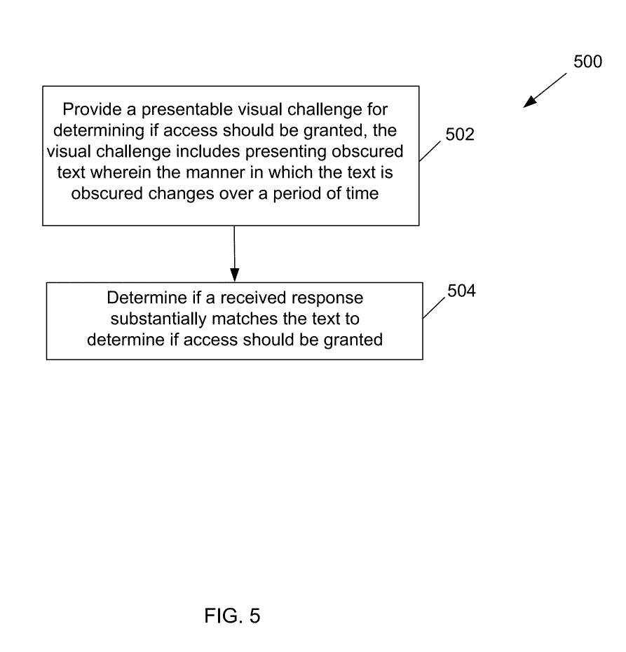

Referring to FIG. 5, a flowchart 500 represents operations of a computing device such as a server (e.g., the challenge manager 220 executed by the server 218, shown in FIG. 2) to prepare and provide a challenge-response test that includes presenting portions of text (e.g., a challenge phrase) that changes over time (e.g., the presentation time of the challenge phrase). Such operations are typically executed by components (e.g., processors, display controllers, etc.) included in a single computing device (e.g., the server 218, shown in FIG. 2), however, operations may be executed multiple computing devices. Along with being executed at a single site (e.g., at the site of the challenge provider 210, shown in FIG. 2), operation execution may be distributed among two or more locations.

Operations of the challenge manager may include providing 502 a presentable visual challenge for determining if access should be granted. The visual challenge includes presenting obscured text wherein the manner in which the text is obscured changes over a period of time. For example, the obscured text of the visual challenge may be provided by presenting frames in which changes to the obscured text are presented by some of the frames over a period of time (e.g., the time during which an access requester is interacting with the visual challenge). Operations may also include determining 504 if a received response substantially matches the text to determine if access should be granted. For example, if a substantial match between a requester's response and the text of the visual challenged is identified, the requester may be considered a human being and access granted. Alternatively, if a match is not detected, the requester may still be considered suspect and another visual challenged may be administered.

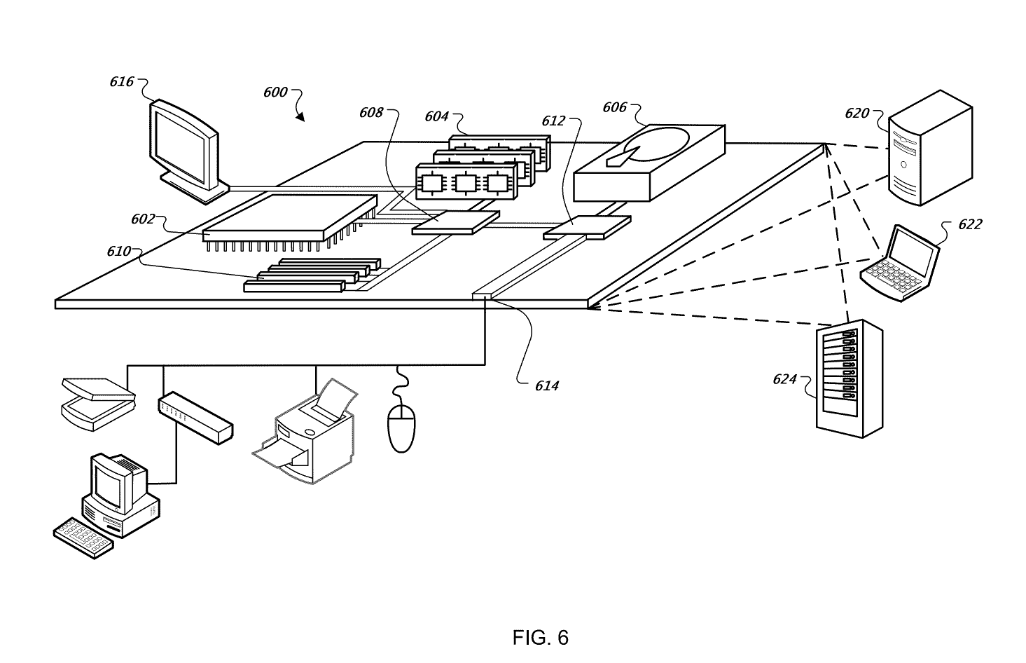

FIG. 6 is a block diagram of computing devices that may be used and implemented to perform operations associated preparing and presenting visual challenges of a challenge-response test such as a CAPTCHA. As such, the computing systems may provide operations similar to a server (e.g., such as the server 218 shown in FIG. 2) or other type of computing device. Computing device 600 is intended to represent various forms of digital computers, such as laptops, desktops, workstations, personal digital assistants, servers, blade servers, mainframes, and other appropriate computers.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and can be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses can be used, as appropriate, along with multiple memories and types of memory. Also, multiple computing devices 600 can be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 can be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, memory on processor 602, or the like.

The high speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 607, display 616 (e.g., through a graphics processor or accelerator), and to high-speed expansion ports 610, which can accept various expansion cards (not shown). In the implementation, low-speed controller 612 is coupled to storage device 606 and low-speed expansion port 614. The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 600 can be implemented in a number of different forms, as shown in the figure. For example, it can be implemented as a standard server 620, or multiple times in a group of such servers. It can also be implemented as part of a rack server system 624. In addition, it can be implemented in a personal computer such as a laptop computer 622. Alternatively, components from computing device 600 can be combined with other components in a mobile device (not shown).

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computing device-implemented method comprising:
providing a presentable visual challenge for determining if access should be granted, the visual challenge includes presenting obscured text wherein the manner in which the text is obscured changes over a period of time; and
determining if a received response substantially matches the text to determine if access should be granted.

2. The computing device-implemented method of claim 1 wherein the manner in which the text is obscured includes blocking a portion of the text from being viewed.

3. The computing device-implemented method of claim 2 wherein the blocked portion of the text extends along a horizontal direction.

4. The computing device-implemented method of claim 2 wherein the blocked portion of the text extends along a vertical direction.

5. The computing device-implemented method of claim 1 wherein the manner in which the text is obscured includes blocking non-overlapping portions of the text from being viewed over the period of time.

6. The computing device-implemented method of claim 1 wherein the manner in which the text is obscured includes randomly presenting different portions of the text over the period of time.

7. The computing device-implemented method of claim 1 wherein the manner in which the text is obscured includes distorting a portion of the text.

8. The computing device-implemented method of claim 1 wherein the manner in which the text is obscured includes presenting a subset of one or more characters included in the text during one portion of the time period and a different subset of one or more characters included in the text during another portion of the time period.

9. The computing device-implemented method of claim 1 wherein providing a presentable visual challenge includes a server device sending data that represents the presentable visual challenge to a client device for display.

10. The computing device-implemented method of claim 1 wherein if a match is determined, granting a client device access to a server device.

11. A system comprising:
a computing device for providing a presentable visual challenge for determining if access should be granted to a resource, the visual challenge includes presenting obscured text wherein the manner in which the text is obscured changes over a period of time; and
wherein the computing device is configured to determine if a received response substantially matches the text to determine if access should be granted.

12. The system of claim 11 wherein the manner in which the text is obscured includes blocking a portion of the text from being viewed.

13. The system of claim 12 wherein the blocked portion of the text extends along a horizontal direction.

14. The system of claim 12 wherein the blocked portion of the text extends along a vertical direction.

15. The system of claim 11 wherein the manner in which the text is obscured include blocking non-overlapping portions of the text from being viewed over the period of time.

16. The system of claim 11 wherein the manner in which the text is obscured includes randomly presenting different portions of the text over the period of time.

17. The system of claim 11 wherein the manner in which the text is obscured includes distorting a portion of the text.

18. The system of claim 11 wherein the manner in which the text is obscured includes presenting a subset of one or more characters included in the text during one portion of the time period and a different subset of one or more characters included in the text during another portion of the time period.

19. The system of claim 11 wherein providing a presentable visual challenge includes the computing device sending data that represents the presentable visual challenge to a client device for display.

20. The system of claim 11 wherein if a match is determined, a client device is granted access to the resource.

21. One or more computer readable media storing instructions that are executable by a processing device, and upon such execution cause the processing device to perform operations comprising:
providing a presentable visual challenge for determining if access should be granted, the visual challenge includes presenting obscured text wherein the manner in which the text is obscured changes over a period of time; and
determining if a received response substantially matches the text to determine if access should be granted.

22. The computer readable media of claim 21 wherein the manner in which the text is obscured includes blocking a portion of the text from being viewed.

23. The computer readable media of claim 22 wherein the blocked portion of the text extends along a horizontal direction.

24. The computing readable media of claim 22 wherein the blocked portion of the text extends along a vertical direction.

25. The computing readable media of claim 21 wherein the manner in which the text is obscured include blocking non-overlapping portions of the text from being viewed over the period of time.

26. The computing readable media of claim 21 wherein the manner in which the text is obscured includes randomly presenting different portions of the text over the period of time.

27. The computing readable media of claim 21 wherein the manner in which the text is obscured includes distorting a portion of the text.

28. The computing readable media of claim 21 wherein the manner in which the text is obscured includes presenting a subset of one or more characters included in the text during one portion of the time period and a different subset of one or more characters included in the text during another portion of the time period.

29. The computing readable media of claim 21 wherein providing a presentable visual challenge includes a server device sending data that represents the presentable visual challenge to a client device for display.

30. The computing readable media of claim 21 wherein if a match is determined, granting a client device access to a server device.
